(19) United States
(12) Patent Application Publication
(10) Pub. No.: US 2010/0161199 A1
(43) Pub. Date: Jun. 24, 2010

(54) Fuel consumption saving system and a method of operation thereof

(76) Inventor: Éric Gauthier, St-Modeste (CA)

Correspondence Address: Franz BONSANG;c/o EQUINOX PROTECTION, 410-1500, Du College, St-Laurent, QC, H4L 5G6, CA

(21) Appl. No.: 12/654,462

(22) Filed: Dec. 22, 2009

Related U.S. Application Data
(60) Provisional application No. 61/193,749, filed on Dec. 22, 2008.

(51) Int. Cl. F02D 41/00

(52) U.S. Cl. 701/103

(57) ABSTRACT

A fuel consumption saving system for an internal combustion engine incorporates a means for determining the actual load factor from a set of first sensors, determining an actual minimum load factor, and modifying the actual values of sensed data in response to the actual minimum load factor thereby to yield actual optimal values for transmission to an engine control unit for controlling the engine.

### CROSS REFERENCE TO RELATED APPLICATIONS

This patent application claims benefit of U.S. Provisional Application for Patent Ser. No. 61/193,749 filed on Dec. 22, 2008, which is incorporated herein by reference.

### FIELD OF THE INVENTION

The present invention relates to internal combustion engines in road vehicles, and is more particularly concerned with a fuel consumption saving system and a method of operation thereof.

### BACKGROUND OF THE INVENTION

Currently and for many years emphasis has been placed upon the need for fuel efficiency in the field of internal combustion engines when used for traction purposes industrially, commercially or domestically, the principal objective being to save fuel in the face of rising production, transport and processing costs.

Accordingly, attention has been paid to engine performance characteristics against the backdrop of operating conditions, both actual and simulated. Considerable work has been undertaken in this latter regard in terms of laboratory testing of engine units and indeed on test tracks where actual working environments can be experienced.

Fuel conservation is especially important for road vehicles, which employ compression or spark ignition engines, to target greater efficiency with concomitant fuel savings at a maximum or optimum level.

Various proposals have tended to focus upon engine performance as a priority in terms of for example the smooth transmission of power, with perhaps subsidiary benefit as far as fuel saving is concerned. One such example is to be found in U.S. Pat. No. 6,022,292 to Goodnight who proposes a vehicle adaptive load-based powershift transmission shift control system for a diesel engine, which responds to various conditions, including the operational status of an auxiliary function driven by the engine, namely a power take off. In such a system relevant parameters are measured and appropriate adjustments are made to the powershift transmission in accordance with load factor values.

There remains a need to provide an ad hoc fuel consumption saving system, which takes account of engine conditions including load factor with the object of optimizing fuel usage.

### SUMMARY OF THE INVENTION

It is therefore a general object of the present invention to provide an improved fuel consumption saving system, and a method of operation thereof.

A specific object of the present invention is to provide such a system which seeks to achieve an actual reduced fuel consumption in accordance with sensed data, and with simulated comparative data to generate appropriate values to be transmitted via a control unit to the engine to function on a reduced and optimal fuel consumption level, depending on a selected operative configuration.

In a first aspect of the invention, there is provided a fuel consumption saving system for use in combination with an electronic control unit of an internal combustion engine of a motor vehicle, the motor vehicle having a plurality of condition and engine parameter sensors connected to the electronic control unit operating the engine, the system comprising a controller adapted for connection to the electronic control unit and to a preselected first set of the sensors and a preselected second set of the sensors, the controller determining, based on respective first sensor values sensed by the first set of the sensors, an actual engine load factor and calculating, for the actual engine load factor, a modified engine load factor corresponding to a predefined efficiency region of operation of the engine, the controller modifying respective second sensor values sensed by a second set of the sensors to actual optimal values therefor corresponding to the modified engine load factor and transmitting the actual optimal values to the electronic control unit, whereby in use the electronic control unit accepts the actual optimal values for the operation of the engine at the predefined efficiency region.

The first set of sensors selected from the following which are provided on the engine per se and/or its transmission elements: exhaust gas recirculation (EGR) angle sensor, barometric atmospheric pressure sensor, boost pressure sensor, fuel temperature sensor, air intake temperature sensor, fuel and oil rail pressure sensors, differential pressure sensor, coolant temperature sensor, and throttle position sensor.

The system of the present invention essentially comprises a pre-programmed silicon chip, which may be embedded in the electronic control unit, and in this respect the system may conveniently be an integral part of the electronic control unit (ECU). In the alternative, the system of the present invention may be separate from the ECU and accordingly may be retrofitted to engines having existing control systems.

According to a second aspect of the invention, there is provided a method for saving fuel consumption of an internal combustion engine of a motor vehicle having a plurality of condition sensors and engine parameter sensors connected to an electronic control unit operating the engine, the method comprising the steps of:
a) determining an actual engine load factor from respective first sensor values sensed by a preselected first set of the sensors;
b) determining from the actual engine load factor a corresponding modified load factor for a predefined efficiency region of operation of the engine;
c) modifying respective second sensor values sensed by a preselected second set of the sensors to actual optimal values therefor corresponding to the modified load factor; and
d) transmitting the actual minimum optimal values to the electronic control unit.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following drawings wherein:

FIG. 1 is a diagrammatic representation of a fuel consumption saving system in accordance with the present invention.

### DETAILED DESCRIPTION OF THE PREFERRED EMBODIMENTS

With reference to the annexed drawing the preferred embodiments of the present invention will be herein described for indicative purpose and by no means as of limitation.

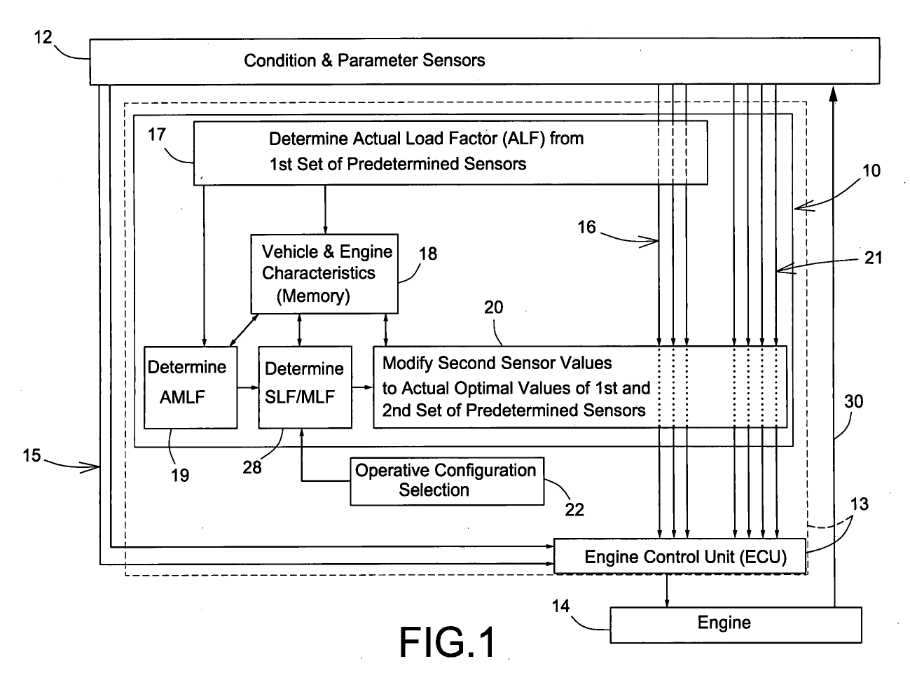

Referring now to FIG. 1, there is shown an embodiment of a fuel consumption saving system, shown generally as 10, and method therefor. The system 10 is in the form of a silicon chip which is connected, or connectable, to a bank of condition and parameter sensors 12 feeding sensed performance data monitored from the sensors 12 along connections, shown as lines 16 and 21, to an engine control unit (ECU) 13 so connected as to control the performance of an internal combustion engine 14. Other parameter sensor lines not used by the present system 10 and directly connected to the ECU 13 are represented by lines 15. The values and data are typically received and transmitted as electrical signals of variable voltage, as is well known in the art. Line 30 from the engine 14 represents the connection of and/or mounting of at least a portion of the sensors 12 to the engine 14 or an area proximal thereto. The connections between sensors 12 and the ECU 13 may be effected by any conventional means known in the art for connecting sensors and electronic components, including wires, wireless transceivers, integrated circuit connections, or the like.

The system 10, i.e. controller 10, receives a first set of first sensor values of the sensed data from a preselected first set of sensors 12 along lines 16 and determines the actual load factor (ALF) therefrom with the actual load factor module or step, shown as 17. The first set of sensors 12 are selected from the following listing, by way of example only:
Exhaust Gas Recirculation (EGR) angle sensor;
Barometric atmospheric pressure sensor;
Boost pressure sensor (mass air flow intake pressure sensor);
Fuel temperature sensor;
Air intake (inlet) temperature sensor;
Fuel and oil rail pressure sensors;
Differential pressure sensor;
Coolant temperature sensor;
Throttle position sensor.

A pre-recorded set of sampled values for sensors 12 is stored in a memory 18 of system 10 and is accessible by modules 17, 19, 28, and 20. The memory 18 may be any type of electronic data storage appropriate for an integrated circuit, including read only memory (ROM), erasable programmable read only memory (EPROM), flash memory, or the like. Thus, the memory store 18 holds information relating to the vehicle and engine characteristics. The information contained in the memory 18 feeds into an actual minimum load factor (AMLF) module or step, shown as 19, as well as a selected load factor (SLF) module or step, shown as 28, which together determine, for example calculate, a modified load factor (MLF) corresponding to a predefined efficiency region of operation of the engine 14. The MLF, at actual optimal values module or step, shown as 20, is used to modify second sensor values collected from a predetermined second set of sensors 12 to the values calculated as relating to the MLF to give actual optimal values. These optimal or altered values, shown as dotted lines 21 running through 20, are then transmitted as controlling data to the ECU 13 which in turn controls the engine 14 accordingly, thereby yielding a modified predetermined fuel consumption saving, corresponding to the predefined efficiency region of operation of the engine 14, whilst maintaining a satisfactory traction performance of the engine 14. For the predetermined second set of sensors 12, the sensors 12 may be selected from the following non-exhaustive listing:
Exhaust Gas Recirculation (EGR) angle sensor;
Barometric atmospheric pressure sensor;
Boost pressure sensor (mass air flow intake pressure sensor);
Fuel temperature sensor;
Air intake (inlet) temperature sensor;
Fuel and oil rail pressure sensors;
Differential pressure sensor;
Coolant temperature sensor;
Throttle position sensor.

Accordingly, one may recognize that the first and second predetermined sets 16, 21 of sensors 12 could be identical to one another.

The memory 18 contains typical pre-recorded respective sampled values of the different parameters for the first and/or second sensor values sensed for a plurality of different road/environmental conditions. These sampled values were previously recorded with the actual engine 14 performing in the respective conditions. The different road/environmental conditions for which respective sampled values are stored and recorded may include the following, without being limited to them:
side winds;
facing winds;
ascending road;
generally flat road (high speed as highways and medium speed as local roads);
sinuous type road;
snowed road (slippery and/or slushy);
all the above conditions at normal, hot and cold temperatures.

The MLF is determined as follows. If optional operative configuration selection module or step, shown as 20, is deployed, a selected operative configuration for the engine 14 is selected by a user, for example using a switch, from a plurality of possible configurations, each operative configuration corresponding to a respective predetermined or predefined efficiency region of operation for the engine 14 and corresponding selected MLF. Typically, the selected operative configuration varies between a maximum fuel savings operative configuration, which is as close as possible to a predetermined maximum efficiency region of operation of the engine 14, intermediate operative configurations having lower predetermined regions of operations, and an non-operative (unmodified) configuration, in which case the operative configuration for the engine 14 and second sensor values are not modified, for example when the system 10 is deactivated. When the system 10 is in non-operative configuration, the sensed data from the preselected first and second sets of parameters 16, 21 are unaltered and transmitted directly to the ECU 13.

Regardless of the selected operative configuration for engine 14, unless the user selects an unmodified operative (i.e. non-operative) configuration, the ALF is received at 19 and the AMLF, corresponding as close as possible to a predetermined maximum efficiency region of operation of the engine based on said actual load factor and, optionally, respective sampled values, is calculated. If the selected operative configuration is the maximum fuel savings operative configuration, then the AMLF is the selected load factor (SLF) used as the MLF at 20. Otherwise, at 28 the AMLF is modified based on the first sensed values, the selected operative configuration, and, optionally, the sampled values, to the corresponding SLF, which is used as the MLF at 20. At 20, the second sensor values are received along line 21 and the second sensor values are modified or adjusted to the values calculated as relating to the MLF, in conjunction with the sampled values, to give actual optimal values. These optimal or altered values (shown as dotted lines running through box 20) are then transmitted as controlling data to the ECU which in turn controls the engine 14 accordingly, thereby yielding a selected fuel consumption saving whilst maintaining a satisfactory traction performance of the engine. In order to assess the actual optimal values, the memory 18 contains typical values of the different parameters for a plurality of different road/environmental conditions that were previously recorded with the actual engine performing in the respective conditions.

It has been found in practice that the use of the fuel consumption saving system of the instant invention can save as much as 30% on a volume basis, when considering the actual minimum load factor (AMLF), the fuel consumption saving will obviously be less upon a selected operative configuration other than the maximum fuel savings operative configuration, if applicable.

It is to be understood that the respective first and second sets of sensors may vary in their selection.

The system, i.e. controller, 10 of the present invention essentially comprises a pre-programmed silicon integrated circuit, i.e. a silicon chip, which may be embedded in the electronic control unit 13, and in this respect the system may conveniently be an integral part of the electronic control unit (ECU), as represented by the stippled line 13. In the alternative, the system 10 of the present invention may be separate from the ECU 13 and accordingly may be retrofitted to engines having existing control systems. Operations at 17, 19, 20, 28 may be implemented pre-programmed modules of steps or instructions coded into the chip.

While a specific embodiment has been described, those skilled in the art will recognize many alterations that could be made within the spirit of the invention, which is defined solely according to the following claims.

I claim:

1. A fuel consumption saving system for use in combination with an electronic control unit of an internal combustion engine of a motor vehicle, the motor vehicle having a plurality of condition and engine parameter sensors connected to the electronic control unit operating the engine, the system comprising a controller adapted for connection to the electronic control unit and to a preselected first set of the sensors and a preselected second set of the sensors, said controller determining, based on respective first sensor values sensed by said first set of the sensors, an actual engine load factor and calculating, for said actual engine load factor, a modified engine load factor corresponding to a predefined efficiency region of operation of the engine, said controller modifying respective second sensor values sensed by said second set of the sensors to actual optimal values therefor corresponding to said modified engine load factor and transmitting said actual optimal values to the electronic control unit, whereby in use the electronic control unit accepts said actual optimal values for the operation of the engine at said predefined efficiency region.

2. The fuel consumption saving system of claim 1, wherein said first set of the sensors comprises at least one of an exhaust gas recirculation angle sensor, a barometric atmosphere pressure sensor, a mass air flow intake pressure sensor, a fuel temperature sensor, an air intake temperature sensor, a fuel rail pressure sensor, an oil rail pressure sensor, a coolant temperature sensor, a differential pressure sensor, and a throttle position sensor.

3. The fuel consumption saving system of claim 1, wherein said second set of the sensors comprises at least one of an exhaust gas recirculation angle recirculation sensor, a barometric atmospheric pressure sensor, a mass air flow intake pressure sensor, a fuel temperature sensor, an air intake temperature sensor, a fuel rail pressure sensor, an oil rail pressure sensor, a differential pressure sensor, a coolant temperature sensor, and a throttle position sensor.

4. The fuel consumption saving system of claim 1, wherein said system further comprises, for a plurality of predefined operating conditions, stored respective sampled values for said second sensor values, said respective sampled values for each said predefined operating condition having been prerecorded with the engine operating in said predefined operating conditions.

5. The fuel consumption saving unit of claim 4, further comprising a read only memory, said respective sampled values being prerecorded in said read only memory.

6. The fuel consumption system of claim 4, wherein said predefined operating conditions and respective sampled values correspond to values for at least one of side winds, facing winds, ascent of road, descent of road, flatness of road, curving of road, presence of snow on road, snow level on road, and external air temperatures.

7. The fuel consumption system of claim 4, wherein said controller determines said actual optimal values based on said modified load factor and said respective sampled values.

8. The fuel consumption system of claim 7, wherein said modified load factor is a corresponding actual minimum engine load factor being as close as possible to a predetermined maximum efficiency region of operation of the engine based on said actual engine load factor and said respective sampled values, said predefined efficiency region of operation of the engine being said predetermined maximum efficiency region of operation.

9. The fuel consumption saving system of claim 7, further comprising an operative configuration selector module for selecting a desired selected operative configuration for the engine corresponding to said predefined efficiency region of operation, said controller calculating a corresponding actual minimum engine load factor being as close as possible to a predetermined maximum efficiency region of operation of the engine based on said actual engine load factor and said sampled values and modifying said actual minimum engine load factor to a selected load factor based on said selected operative configuration and said sampled values, said modified load factor being said selected load factor.

10. The fuel consumption saving system of claim 1, wherein said controller is comprised of a pre-programmed silicon integrated circuit embedded in the electronic control unit.

11. The fuel consumption saving system of claim 1, wherein said controller is comprised of a pre-programmed silicon integrated circuit connectable to the electronic control unit and to said first and second sets of the sensors.

12. A method for saving fuel consumption of an internal combustion engine of a motor vehicle having a plurality of condition sensors and engine parameter sensors connected to an electronic control unit operating the engine, the method comprising the steps of:
a) determining an actual engine load factor from respective first sensor values sensed by a preselected first set of the sensors;
b) determining from the actual engine load factor a corresponding modified load factor for a predefined efficiency region of operation of the engine;
c) modifying respective second sensor values sensed by a preselected second set of the sensors to actual optimal values therefore corresponding to said modified load factor; and
d) transmitting the actual minimum optimal values to the electronic control unit.

13. The method of claim 12, wherein said respective first sensor values sensed from said preselected first set of the sensors are sensed from at least one of an exhaust gas recirculation angle sensor, a barometric atmosphere pressure sensor, a mass air flow intake pressure sensor, a fuel temperature sensor, an air intake temperature sensor, a fuel rail pressure sensor, an oil rail pressure sensor, a coolant temperature sensor, a differential pressure sensor, and a throttle position sensor.

14. The method of claim 12, wherein said respective second sensor values sensed from said preselected second set of the sensors are sensed from at least one of an exhaust gas recirculation angle recirculation sensor, a barometric atmospheric pressure sensor, a mass air flow intake pressure sensor, a fuel temperature sensor, an air intake temperature sensor, a fuel rail pressure sensor, an oil rail pressure sensor, a differential pressure sensor, a coolant temperature sensor, and a throttle position sensor.

15. The method of claim 12, wherein said controller calculates said actual optimal values based on said actual engine load factor and respective sampled values for said second sensor values for a plurality of predefined operating conditions for the engine, said respective sampled values for each said predefined operating condition having been prerecorded with the engine operating in said predefined operating conditions.

16. The method of claim 15, wherein said predefined operating conditions and said respective sampled values therefore correspond to values for at least one of side winds, facing winds, ascent of road, descent of road, flatness of road, curving of road, presence of snow on road, snow level on road, and external air temperatures.

17. The method of claim 15, wherein said modified load factor is a corresponding actual minimum engine load factor being as close as possible to a predetermined maximum efficiency region of operation of the engine based on said actual engine load factor and said respective sampled values.

18. The method of claim 15, further comprising, prior to the step of determining an actual engine load factor, the step of selecting a desired selected operative configuration for the engine corresponding to said desired level of efficiency, said modified load factor being a selected load factor calculated by modifying a corresponding actual minimum engine load factor, said actual minimum engine load factor being as close as possible to a predetermined maximum efficiency region of operation of the engine based on said actual engine load factor and said sampled values, to a selected load factor based on said selected operative configuration and said sampled values.
